(19) United States
(12) Patent Application Publication
(10) Pub. No.: US 2008/0109348 A1
(43) Pub. Date: May 8, 2008

(54) Credit System with Over-Limit Analysis

(75) Inventors: Puneet Saxena, Prospect Heights, IL (US); Abhijit Bhattacheryya, Mount Prospect, IL (US); James F. Connaughton, Bannockburn, IL (US); Michael A. Vires, LaGrange, IL (US); Michael E. Crouse, Itasca, IL (US)

Correspondence Address: MICHAEL BEST & FRIEDRICH LLP, Two Prudential Plaza, 180 North Stetson Avenue, Suite 2000, CHICAGO, IL, 60601, US

(73) Assignee: HSBC FINANCE CORPORATION, Prospect Heights, IL (US)

(21) Appl. No.: 11/555,863

(22) Filed: Nov. 2, 2006

(51) Int. Cl. G06Q 40/00

(52) U.S. Cl. 705/38

(57) ABSTRACT

An over-limit analysis system is presented for approving an over-limit amount in real-time and in response to a credit request from a borrower, which includes an over-limit amount. An over-limit cushion to which the borrower is entitled is determined by comparing financial and other information collected from the borrower to analogous account data relating to the credit accounts of other borrowers according to an optimal strategy. As a result, the borrower may be approved for an over-limit amount as a function of an over-limit cushion associated with accounts that have similar account-related data. So that the borrower's credit account-related information may be compared with the account data of other borrowers, a segmentation model is used to organize the account data into segments according to one or more optimization constraints. Each segment is associated with an over-limit cushion so that the over-limit cushion for each segment is optimized according to one or more optimization constraints.

### BACKGROUND

The use of credit, particularly with credit cards, to purchase goods and services has become a necessary and an essential part of the modern economy. Unfortunately, the process of obtaining credit is generally cumbersome and time-consuming. In most cases, a person or group (a “borrower”) must apply for credit from a lender (a “credit provider”) long before the credit is available to the borrower. Borrowers include individuals and groups that have a credit account with a credit provider and, at some point in time, an interest in purchasing goods and/or services offered by a merchant. Credit providers include individuals and groups that provide revolving and non-revolving loans (“credit”), and those authorized to provide credit on behalf of such individuals or groups, such as employees and affiliates. If the borrower is approved, the borrower is generally approved for a specific amount of credit (a “credit limit”). As a borrower uses the credit, the amount of credit available to the borrower (the borrower's or the account's “credit open to buy”) decreases by the amount of credit used. In addition, if the borrower needs to access an amount of credit that exceeds the borrower's credit open to buy (an “over-limit amount” or “additional credit”), the borrower must apply for an increase in the borrower's credit limit according to the same cumbersome process as was necessary for the borrower to obtain the credit in the first place.

From the credit provider's perspective, the traditional methods of providing credit or an increase in credit limit, such as in connection with a credit card, have some advantages. For example, the traditional methods afford the credit provider a great deal of time to verify the information provided by the borrower on an application for credit or for an increase in credit limit, determine the risks involved in approving the credit or an increase in credit limit, and determine the terms under which the credit or increase will be provided. The terms and conditions may include a particular interest rate, credit limit, increase in credit limit and/or payment schedule.

To determine whether a borrower's request for additional credit should be approved, traditional methods focus on the number of accounts in a credit provider's portfolio for which one or more payments have not been made or proven to be uncollectible (“Bad Accounts”). For example, a credit provider may determine that among the accounts for which $100.00 in additional credit was approved, 20% of the accounts have gone bad. The credit provider may use this information to deny a borrower's request for $200.00 in additional credit. Such denial may not be justified if, for example, the number of Bad Accounts for which $200.00 in additional credit was granted was only 5%.

From the borrower's perspective, it is extremely frustrating to attempt to purchase a product or service using credit, only to discover that the purchase price exceeds the borrower's credit limit and additional credit cannot easily be obtained. In this situation, the borrower may delay making the purchase or forego making the purchase altogether, which results in a delayed or lost sale for the merchant and delayed or lost interest for the credit provider.

Credit providers who use traditional methods for providing credit miss opportunities to maximize the credit they provide and, as a result, miss the opportunity to collect additional interest and/or fees, even if the risk of providing the additional credit is within the credit provider's risk tolerance. For example, the traditional methods for providing credit do not allow a credit provider to provide an over-limit amount to a borrower, in real-time. For example, a borrower may wish to use credit to make a purchase, in a store or on-line, for a price greater than the borrower's credit open to buy. Because the traditional methods are time consuming and cumbersome, the borrower may use cash or other sources of financing rather than wait for the additional credit to be approved. The traditional methods lack the flexibility needed to provide the borrower with an over-limit amount in a time frame that is sufficiently short to allow the borrower to use the credit when the borrower is ready to make a purchase.

The traditional method for providing credit may cause merchants to miss opportunities as well. Without the ability to obtain virtually instantaneous additional credit, a borrower may forego making purchases that would have been made if the borrower could have accessed additional credit promptly, thereby depriving the merchant of a timely sale. Merchants include individuals and groups that sell goods and/or services, and those authorized to sell goods and/or services on behalf of such individuals or groups, such as employees and affiliates. The merchants may make their goods and/or services available, for example, in retail locations, wholesale locations, catalog stores, and warehouses, over the phone, and/or over a computer network (“on-line”).

### SUMMARY

A system is presented that enables real-time approval of credit that exceeds the credit then available to a borrower in a credit account (an “over-limit analysis system”). The over-limit analysis system, along with a “strategy development system,” may be implemented as part of a larger system that determines whether to approve a borrower's request for credit (a “credit system”). The over-limit analysis system may receive a credit request from a borrower via a credit request system when, for example, the borrower attempts to make a purchase using a credit account. The over-limit analysis system determines whether and by how much the credit request exceeds the borrower's credit open to buy in the account. If the credit request exceeds the borrower's credit open to buy, the over-limit analysis system determines whether to approve an over-limit cushion approximately equal to the amount by which the credit request exceeds the borrower's credit open to buy. The credit analysis system may further analyze the credit request to determine whether the credit request, including any over-limit cushion, should be approved. In addition, the credit analysis system may communicate the approval or denial of the credit request to the borrower via the credit request system.

The strategy development system delivers an optimal strategy via a segmentation model developed by a segmentation module and via an optimization module. The segmentation module develops the segmentation model by training the model with account-related data (“training data”). The model is trained to identify a relationship between types of training data (the “independent variables”, such as mortgage loan amount, total number of trade lines, age of oldest trade, and number of inquiries into a trade line in last twelve months), and a particular consideration (the “dependent variable”, such as a risk level). The risk level may be defined as the amount of money the credit provider is willing to lose for each dollar of credit provided. To determine the relationship, the training data may be repeatedly segmented according to the account-related independent variable that best predicts the risk level according to, for example, a Chi-Squared Automatic Interaction Detection (CHAID) method. Once the relationship has been established from the training data, the relationship may be used to predict the risk level for a particular credit request according to the types of data relating to the account against which the credit request is made.

The optimal strategy developed by the optimization module defines a maximum amount that may be approved for each segment created by the segmentation module (the “over-limit cushion”). In general, the optimization module delivers an optimal strategy based on the objective function and one or more constraints. The objective function may include maximization of profit or minimization of risk. The optimization constraints may include limiting the minimum approved transaction amount, and/or limiting the total amount of money the credit provider is willing to lose for each dollar of credit provided per the total approved transaction amount.

The over-limit analysis system uses the optimal strategy created by the strategy development system to determine whether to approve an over-limit cushion and the amount of the cushion. The over-limit analysis system includes an over-limit processing module and a cushion module. The over-limit processing module determines that a credit request includes an over-limit amount if the amount of the credit request is greater than the account's credit open to buy. If it is, the over-limit amount and thus the credit request includes an over-limit amount approximately equal to the difference between the credit request and the account's credit open to buy. The over-limit cushion module may then identify the over-limit cushion to which the borrower is entitled. To perform this identification, the over-limit cushion module examines the segments produced by the segmentation model to determine which segment, if any, of which the borrower's account is a member. In addition, the over-limit cushion model uses the over-limit cushions produced for each segment by the optimization model to identify the over-limit cushion associated with the segment of which the borrower's account is a member. The over-limit processing module uses the identified over-limit cushion to determine whether to approve or deny the over-limit amount by comparing the over-limit cushion with the over-limit amount. If the over-limit cushion is less than the over-limit amount, the over-limit amount and thus the credit request will be denied. If the over-limit cushion is greater than or equal to the over-limit amount, the over-limit cushion will be approved. However, the credit analysis system may perform one or more additional analyses in connection with the credit request before the credit request, including the over-limit cushion, is approved.

### BRIEF DESCRIPTION OF THE DRAWINGS

The components in the following figures are not necessarily to scale, emphasis instead being placed upon illustrating the general principles. Moreover, in the figures, the same reference symbols designate the same components.

FIG. 1 is a block diagram of a real-time over-limit analysis system implemented as part of a credit system.

FIG. 2 is a block diagram of a real-time over-limit analysis system in communication with a first exemplary credit request system.

FIG. 3 is a block diagram of a real-time over-limit analysis system in communication with a second exemplary credit request system.

FIG. 4 is block diagram of a real-time over-limit analysis system in communication with a third exemplary credit request system.

FIG. 5 is a flow chart of a method for determining over-limit cushions.

FIG. 6 is an example of an optimal strategy produced by a strategy development system.

FIG. 7 is a swim-lane representation of a method for analyzing an over-limit amount in real-time.

FIG. 8 is a swim-lane representation of a method for analyzing a credit request in real-time.

### DETAILED DESCRIPTION

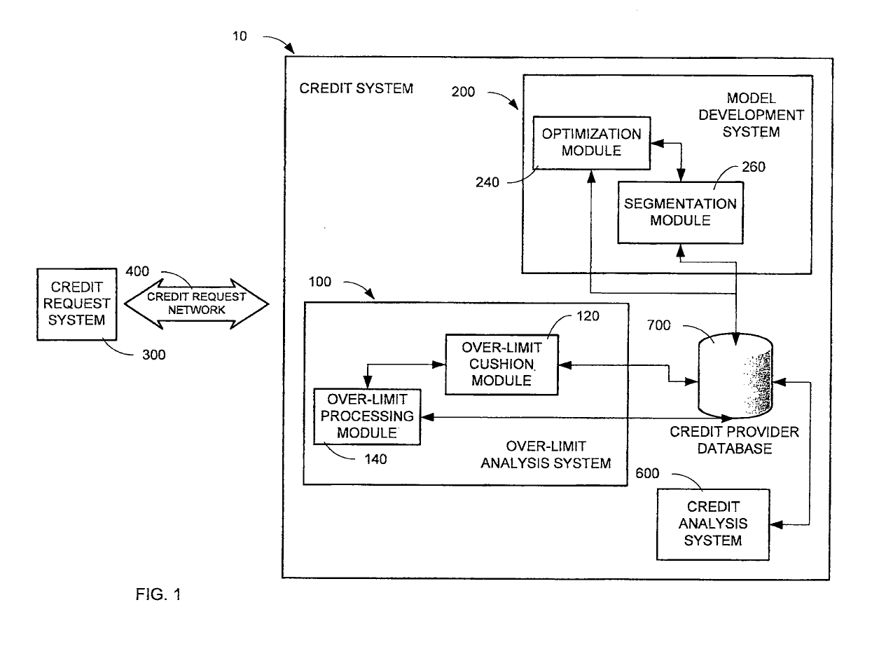

FIG. 1 shows an example of an over-limit analysis system 100 that enables a borrower to request and be denied or approved for an amount of credit that exceeds the borrower's credit open to buy in real-time and according to an optimal strategy. A “borrower” may include an individual, group of individuals, corporation, or partnership, an entity acting on behalf of the borrower, such as a merchant, individual, group of individuals, corporation, or partnership that requests an amount of credit from the borrower's credit account. The over-limit analysis system 100 also enables a credit provider to determine an over-limit amount that the credit provider is willing to provide to the borrower (the over-limit cushion). The over-limit analysis system 100 may be implemented as part of a credit system 10 that allows credit to be requested, approved or denied and communicated on a per transaction basis in real-time. The credit system 10 enables, for example, a borrower in the process of purchasing goods and/or services from a merchant to request credit in the amount of the purchase price. In addition, if the purchase price exceeds the borrower's credit open to buy, the over-limit analysis system 100 will interpret the credit request as including an implicit request for the over-limit amount. A borrower's credit open to buy includes the credit limit on the borrower's credit account minus any credit used by the borrower. Thus, if a borrower has a non-revolving line of credit, the credit open to buy will reduce as the amount of credit used increases. If the borrower has a revolving line of credit, such as a credit card, the credit limit will be restored as the borrower repays the credit used and/or any interest due.

The credit system 10 may be placed in communication with a credit request system 300 via a credit request network 400. In general, the credit system 10 receives a credit request from a borrower via the credit request system 300 and one or more networks (collectively the “credit request network 400”). The credit request may be received by the credit system 10 through a firewall and/or an interface, such as application programming interface (API) (not shown).

The credit request system 300 may include hardware and/or software that enable a borrower to make a credit request to a credit provider. The credit request system 300 may include one or more input and output devices. Examples of input devices include card readers, scanners, keyboards, microphones, voice recognition systems, trackballs, and mice. The output device may be any type of visual, manual, audio, electronic or electromagnetic device capable of communicating information from a processor or memory to a person or to another processor, memory, network, bus and/or an interface. Examples of output devices include monitors, speakers, liquid crystal displays, and ports or connectors for coupling to networks, buses, and/or interfaces. Alternatively, the input and output devices may be included in a single device such as a monitor with touch screen capability, computer, processor or memory coupled with the processor via a network.

If a credit request is made by a borrower in connection with a purchase from a merchant and the credit request is approved by the credit system 10, the credit system 10 may make payment to the merchant directly or to an account specified by the merchant. In contrast, if a credit request is made by a borrower in connection with a request for an advance, such as a cash advance, and the credit request is approved by the credit system 10, the credit system 10 may direct the credit request system 300 to make payment to the borrower. For example, the credit request system 300 may include an automatic teller machine (ATM) by which a borrower may request a cash advance and an over-limit amount in connection with the borrower's existing credit account. If approved, the credit system 10 may instruct the ATM to dispense cash to the borrower in the amount of the approved cash advance. In another example, the credit system 10 may instruct a credit request system 300 to deposit funds, including an over-limit cushion, into an account specified by the borrower in the amount of the approved advance.

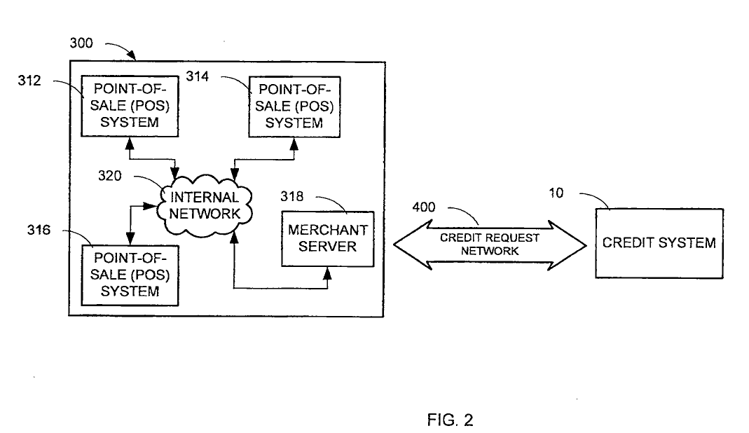

Examples of credit request systems are shown in FIGS. 2 through 4. An example of a credit request system 300 implemented in a merchant's physical store is shown in FIG. 2. The credit request system may include one or more point-of-sale (POS) systems 312, 314, 316 through which a credit request may be communicated to the credit system 10. For example, the POS systems 312, 314, 316 may include cash registers and/or other devices for communicating with the credit system 10. As shown in FIG. 2, the credit request system 300 includes multiple POS systems 312, 314, 316 that may communicate with a server, such as the merchant server 318 over an internal network 320. In this case, the merchant server 318 communicates the credit requests to the credit system 10 over the credit request network 400. The credit request network 400 may be a dedicated network or a shared network, such as the Internet, between the credit request system 300 and the credit system 10. The merchant server 318 may be located in the merchant's store, or in a different location, such as the merchant's central office or headquarters.

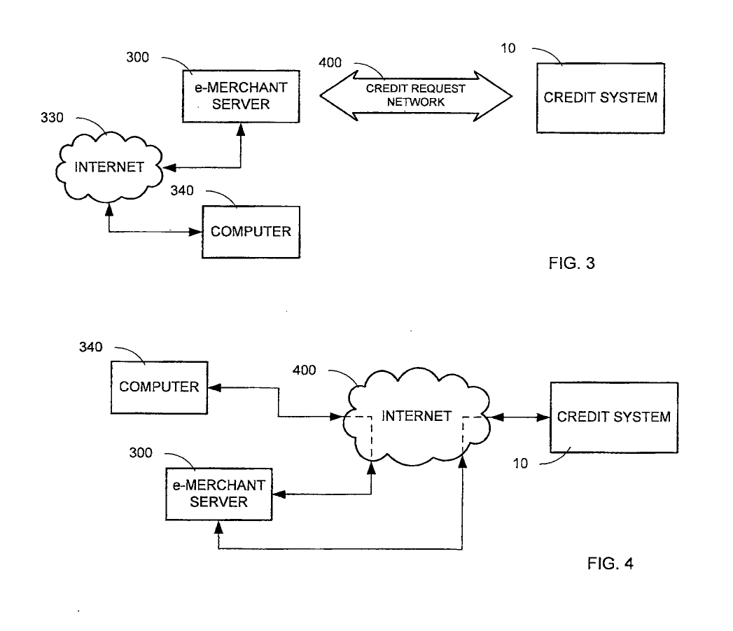

Instead of making purchases from a physical store, the borrower may make purchases from an on-line merchant (an “e-Merchant”). As shown in FIGS. 3 and 4, the borrower may access an e-Merchant via a computer 340, such as a desktop or laptop personal computer (PC), a personal digital assistant (PDA) or other device that may be used to process digital information and communicate digital information over a network. As shown in FIGS. 3 and 4, the borrower may communicate with the e-Merchant over the Internet. However, communication may be enabled via any type of network. Although it is the borrower that makes payment for purchases using a line of credit, it is generally the e-Merchant who communicates the credit request to the credit system 10. Thus, the e-Merchant server may serve as the credit request system 300. The e-Merchant may communicate with the credit system 10 via a network, such as a dedicated network (FIG. 3) or a shared network, such as the Internet 400 (FIG. 4).

As shown in FIG. 1, the credit system 10 may include an over-limit analysis system 100, a strategy development system 200, a credit analysis system 600, and a credit provider database 700. The strategy development system 200 develops the optimal strategy according to account-related information of other borrowers. The strategy development system 200 includes a segmentation module 260, which generally creates a segmentation model that includes rules (“segmentation criteria”) according to which credit accounts are to be placed into one of multiple segments. In addition, the segmentation model defines segments, which include accounts that are homogeneous with each other in value, risk and behavior. The strategy development system 200 also includes an optimization module 240, which generally identifies the optimal over-limit cushions that are to be associated with the segments, thus creating the optimal strategy.

The over-limit analysis system 100 determines whether the credit request includes an over-limit amount, whether the creditor is willing to provide the borrower with an over-limit cushion, and the amount of the over-limit cushion the credit provider is willing to provide. The over-limit analysis system 100 compares information relating to, for example, the borrower's credit account, the transaction amount, and the over-limit amount with the optimal strategy created by the strategy development system 200 to determine the over-limit cushion to which the borrower is entitled, if any. The over-limit analysis system 100 associates the borrower's account with a segment defined by the account parameters, which most closely corresponds to the borrower's account information, and may approve the borrower for the over-limit cushion associated with the corresponding segment. The over-limit analysis system 100 generally includes an over-limit processing module 140 and an over-limit cushion module 120, both of which determine whether a borrower is entitled to an over-limit cushion. The over-limit cushion module 120 may also determine the amount of the cushion.

The credit request system 300, over-limit processing module 140 and over-limit cushion module 120 of the over-limit analysis system 100, and the optimization module 240 and segmentation module 260 of the strategy development system 200 and/or the credit analysis system 600 may reside together or on separate devices, such as servers, memories or the like, in any combination. The credit request system 300, over-limit processing module 140, over-limit cushion module 120, the optimization module 240, segmentation module 260 and the credit analysis system 600, separately or in any combination, may include one or more processors and one or more computer-readable memories alternately or in addition to the credit provider database 700. The memories, such as the credit provider database 700, may include any type of fixed or removable digital storage device and, if needed, a device for reading the digital storage device. Storage and reading devices may include floppy disks and floppy drives, CD-ROM disks and drives, optical disks and drives, hard-drives, RAM, ROM, servers and other such devices for storing digital information. The modules may store and access data in their memories and/or other databases, such as the credit provider database 700. The software includes computer instructions or software code that performs operations on data. The modules 300, 140, 120, 240, 260 may include or access one or more processors that manipulates data. The credit request network 400, the internal network shown in FIG. 2, and any of the communication paths shown in FIGS. 1-4 provide a channel for the electromagnetic propagation of virtually any type of electromagnetic communications at various frequencies, such as radio frequency (RF), microwave, millimeter-wave, and optical. Examples of channels include wired, wireless, LAN, WLAN, intranet, Internet, infrared, and combinations of such channels.

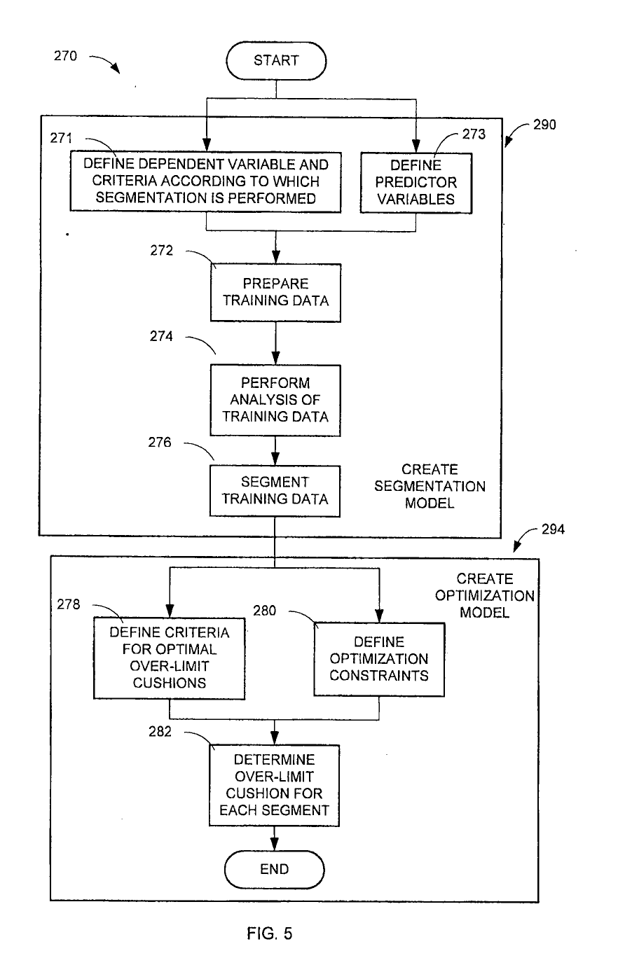

An example of a method by which the strategy development system 200 may develop an optimal strategy is shown in FIG. 5 and generally includes creating a segmentation model in step 290 and using the segmentation model to create the optimal strategy in step 294. A segmentation model may be created in step 290 according to, for example, a statistical segmentation method and by “training” the model with known account-related data. The account-related data selected to “train” the model is referred to as the “training data.” The purpose of training the model is to identify a relationship between types of training data (the “independent variables”, such as mortgage loan amount, total number of trade lines (credit accounts), age of oldest trade line, and inquiries into a trade line in last twelve months or other timeframe), and a particular consideration (the “dependent variable”, such as a risk level). Once this relationship has been established from the training data, the relationship may be used to predict a future value of the dependent variable from generally known independent variables. For example, while a credit provider generally has access to account-related information that reflects a borrower's past behavior with respect to the borrower's account, the credit provider does not know the actual risk associated with granting the borrower an over-limit cushion for a particular transaction. However, using the relationship identified by the segmentation model between the independent variables (the borrower's past account-related information) and the dependent variable (the risk level), the credit provider may predict the risk of non-payment that will be incurred if the credit provider grants an over-limit cushion to the borrower for the particular transaction.

Creating a segmentation model 290 includes defining independent variables in step 273 and defining a dependent variable and the criteria according to which the strength of the relationships between the independent variables and the dependent variable is judged (one or more segmentation criteria) in step 271. The dependent variable and the segmentation criteria are generally related and may be selected to meet a business goal such as, the credit provider's risk tolerance. In general, the primary risk for a credit provider is that some or all of the credit provided will not be repaid. The risk of non-payment may be quantified from credit account-related data in a number of ways. For example, the risk of non-payment may be quantified by determining the number of accounts in the credit provider's portfolio for which an over-limit amount was approved and went bad (the “Bad Accounts”). In another example, the risk of non-payment may be quantified by determining the number of dollars at risk for non-payment for each over-limit amount that was approved (the “Bad Dollars”). If the credit provider is operating within an acceptable level of risk, the credit account-related data may be segmented so that the risk of non-payment, as expressed in terms of Bad Accounts or Bad Dollars, is maintained at a desired level.

For example, if the segmentation criteria includes maintaining an acceptable level of risk on a per transaction basis, the dependent variable may be defined as the acceptable level of risk. In one example, the acceptable level of risk may be defined as the amount of money the credit provider is willing to lose for each dollar (or any currency unit) of credit the credit provider provides for a given transaction (Bad Dollars). The following is an example of the way in which Bad Dollars (the dependent variable) may be defined, depending on certain account indicators as described below.

Bad Dollars=transaction amount−credit open to buy (1)

Bad Dollars=transaction amount−credit open to buy (if days delinquent≦1 and account=bad) (2)

In this example, the Bad Dollars for a given transaction are generally those that exceed a borrower's credit open to buy as expressed in equation (2). However, if there is some indication that the borrower poses an even greater risk of non-payment, the Bad Dollars will equal the entire transaction amount as in equation (1). An account may be considered “Bad” if the borrower associated with the account is in bankruptcy or pre-bankruptcy, or has had a charge off or 60 days past due (“DPD”). A charge off is the removal of an account from a creditor's books as an asset after the account has been delinquent for a period of time (for example 180 days). However, the borrower is still responsible for paying any money owed on the account. 60 DPD indicates that the borrower has defaulted on a payment to an account by at least 60 days, and thus the creditor may include information regarding the default in the borrower's credit file.

The independent variables are types of account-related information that may have a relationship with the dependent variable and are used to segment the training data (in other words, train the segmentation model). The independent variables may include all or some of the data that may be available for accounts, but generally not personal data. In the present example, some or all of the available account-related information (except the dependent variable), such as age of the account on bureau (the time duration for which a credit history has been available on a credit bureau), bankruptcy prediction score, number of days a payment has been delinquent, delinquency prediction score, and transaction amount may be defined as independent variables. The number of variables used to train the segmentation model may be limited by the available data and/or the platform used to implement the model. For example, Fair, Isaac and Company Incorporated's TRIAD™ platform permits approximately 50 independent variables to be used. In another example, Fair, Isaac and Company Incorporated's StrategyWare™ platform permits approximately 100 independent variables to be used.

In step 272 the training data may be prepared. In general, the training data does not include information relating to the identification of individual borrowers, such as information relating to age, race and gender. The data may be summarized at the account level. For example, multiple fee transactions for the same account in a given month may be summarized into a single fee transaction for that month. Summarizing the data at the account level may include eliminating unusual data values (“outliers”), limiting the range of values to those that fall within a given minimum and maximum value (“capping”), and imputing the eliminated data with values such as a mean or median of the data from all accounts (“imputation”).

In step 274 an analysis of the data is performed. The analysis helps in establishing the bad rate, approval rate and other statistics used to benchmark the current strategy. The benchmarks may be used for improving the performance of the optimal strategy.

In step 276 the training data is segmented. In general, the training data may be segmented so that each account from which the training data was obtained will belong to a segment (a group of one or more accounts). One example of a method that may be used to segment the training data is a decision tree-based method. Tree-based methods segment the training data by finding the independent variable that best predicts the dependent variable and grouping the training data according to values of the predictor into two or more segments. The process repeats for each segment based on the segmentation criteria until there is no independent variable that improves the accuracy of the prediction. For example the training data may be segmented according to a Chi-Squared Automatic Interaction Detection (“CHAID”) method. CHAID is a tree-based method that, each time the training data is segmented, determines the independent variable that best predicts the dependent variable according to, for example, a Chi-squared test of independence. Segmenting the training data according to a CHAID method may be performed using software, such as KnowledgeSTIJDIO® by Angoss Software Corporation.

In addition, creating the segmentation module (step 290) may include verifying the accuracy of the segmentation model (not shown). Verifying the segmentation module may include applying the segmentation model to known account-related data that was not used in creating the segmentation model (the test data) to determine if the segmentation model accurately predicts the dependent variable (such as Bad Dollars). The test data is analyzed according to the segmentation model to determine how accurately the independent variables predict the dependent variable. The accuracy of the segmentation model may be determined according to how closely the value of the predicted dependent variable matches that of the training dependent variable. If it is determined that these values do not match sufficiently (as defined by a predetermined criterion), additional information is examined to determine the one or more causes of the deviation. The one or more causes may include, for example, any policy changes (changes in the economic environment).

Next, the optimal strategy is created (step 294). As shown in FIG. 5, creating optimal strategies (step 294) generally includes defining optimization constraints in step 280 and determining the over-limit cushions for each segment in step 282. Similarly to defining a dependent variable for the segmentation model, the optimization constraints may be selected to meet a business goal. Examples of optimization constraints include maximizing the approved transaction amount, and minimizing the “Bad Rate.” The following is an example of the way in which the bad rate may be defined:

$$Bad Rate = \frac{total Bad Dollars}{total approved transaction amount} \qquad ( 3 )$$

The optimization constraints include assigning each segment only one over-limit cushion, a limit on the maximum over-limit cushion, a limit on the maximum transaction amount that will be approved, a limit on the minimum number of accounts that will be approved, the total transaction amount that will go bad after being approved, and the total number of accounts that will go bad after being approved. The over-limit cushions are determined in step 282 according to, for example, an optimization method, and the optimization constraints. The optimization may be defined as Integer Programming Optimization Problem, which may be solved according to a Branch and Bound Method.

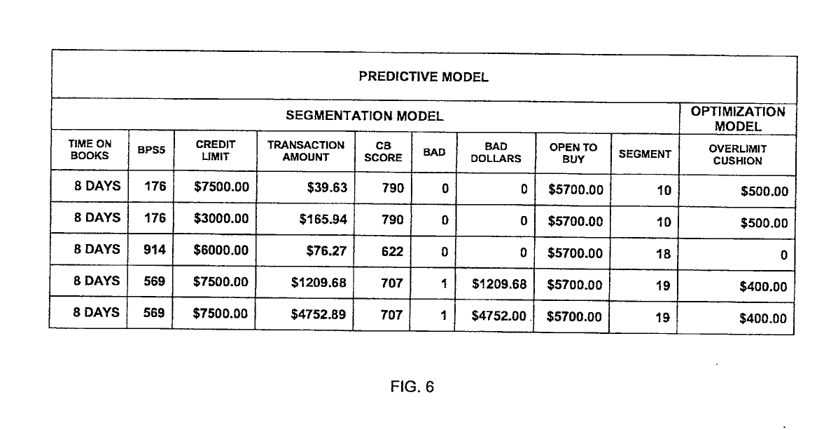

A portion of an exemplary optimal strategy is shown in FIG. 6. The optimal strategy includes a segmentation model that is generally produced by the segmentation module 260. In this example, the segmentation model includes a total of 24 segments, only three (3) of which are shown, The three segments are identified in FIG. 6 by the segment numbers 10, 18 and 19 in the second column from the right. The segmentation model defines the requirements for membership in each of the segments, which are given in terms of information related to a credit account (the independent variables). The independent variables in this example include the following: time on books of the account, bankruptcy prediction score (BPS), credit limit transaction amount, transaction amount, credit bureau score (CB Score), whether the account is Bad, number of Bad Dollars, and amount that is open to buy.

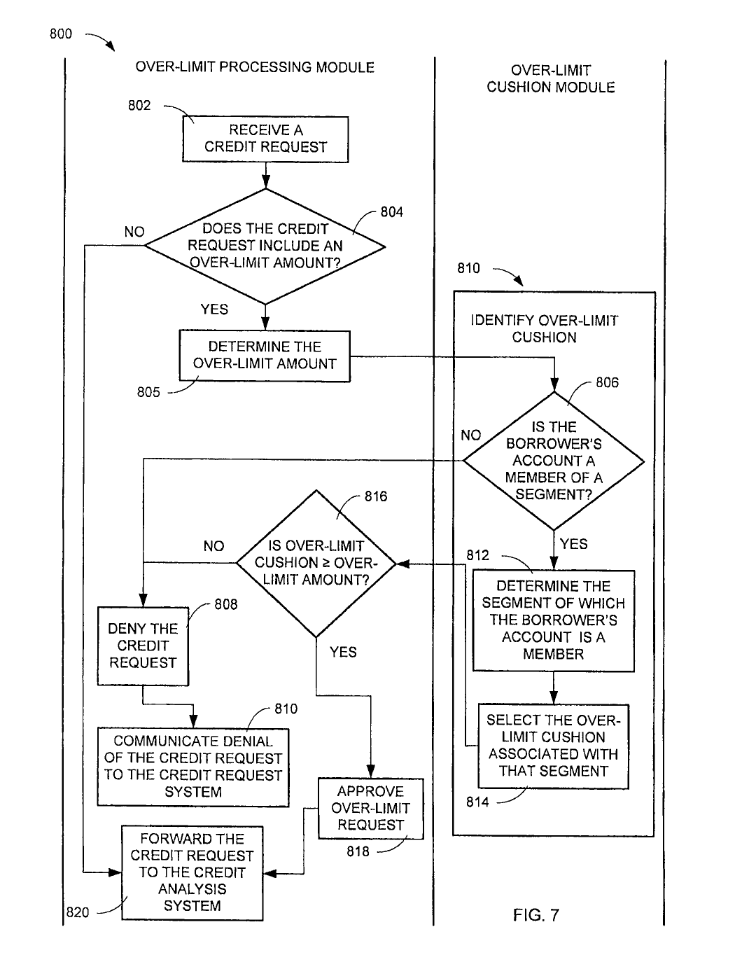

For the example shown in FIG. 6, accounts were segmented according to how well each of the independent variables predicted an acceptable level of risk (a segmentation criterion). The optimal strategy defines the over-limit cushion (shown in the right-most column) associated with each segment. In the example shown in FIG. 6, an over-limit cushion of $500.00, $0.00 and $400.00 are associated with segments 10, 18 and 19, respectively. The segmentation membership for each account and the values of the over-limit cushions for each segment reflect the fact that the following independent variables were found to have the greatest influence on the level of risk: the time on books of the account and the CB Score. An example of a method for analyzing an over-limit amount in real-time to determine the over-limit cushion to which a borrower is entitled, if any, (an “analysis method”) is shown in FIG. 7. The analysis method 800 will be discussed with reference to FIG. 1 and FIG. 7. In step 802, the over-limit processing module 140 receives a credit request from the credit request system 300 via a network, such as the credit request network 400. The credit request may be initiated by a borrower in connection with a purchase or request for an advance. Information relating to the credit request may be entered into the credit request system 300 by the borrower. The information may include something that identifies the borrower's credit account, such as a credit account number, and the total amount of the purchase price.

Upon or after receiving the credit request in step 802, the over-limit processing module 140 determines whether the credit request includes an over-limit amount in step 804. The over-limit processing module 140 may make this determination by accessing information relating to the borrower's account, such as the borrower's credit open to buy, from a database, such as the credit provider database 700. In addition, the over-limit processing module 140 may assemble the information relating to the borrower's account into a format acceptable to the optimization method. For example, the data may be assembled into one or more matrices. To determine whether the credit request includes an over-limit amount, the over-limit processing module 140 compares the amount included in the credit request with the credit open to buy. If the amount included in the credit request is less than or equal to the borrower's credit open to buy, the over-limit processing module 140 will determine that the credit request does not include an over-limit amount and, in step 820, may communicate the credit request to the credit analysis system 600.

If the over-limit processing module 140 determines that the amount included in the credit request is greater than the credit available in the borrower's account, the over-limit processing module 140 may conclude that the credit request includes an over-limit amount and may interpret the credit request as including an implicit request for the over-limit amount. In this case, the over-limit processing module 140 may determine the over-limit amount in step 805 according to either of the following relationships.

over-limit amount=credit request−borrower's credit open to buy, if credit request>borrower's credit open to buy (4)

over-limit amount=0, (5)

if credit request≦borrower's open to buy

### The over-limit processing module 140 may communicate the credit request, including any over-limit amount, to the over-limit cushion module 120 to identify the over-limit cushion to which the borrower is entitled.

In general, the over-limit cushion module 120 identifies the over-limit cushion for a given transaction in step 810. To identify any over-limit cushion to which the borrower may be entitled, the over-limit cushion module 120 generally determines whether the borrower's account is a member of a segment (step 806), determines which segment the borrower's account is a member (step 812), and selects the over-limit cushion associated with the segment of which the borrower's account is a member (step 814). To determine whether the borrower's account is a member of a segment (step 806), the over-limit cushion module 120 may identify and access the borrower's account from a database, such as the credit provider database 700, identify and access the segmentation model from the segmentation module 260 or a database, such as the credit provider database 700, and compare data relating to the borrower's account with the data associated with each segment in the segmentation model. If the data associated with the borrower's account does not fall within the data ranges defining each segment, the borrower's account is not a member of any segment of the segmentation model. In this case, the over-limit cushion module 120 communicates this information with the over-limit processing module 140. The over-limit cushion module 140 denies the over-limit amount and thus, the credit request 808.

If, however, the borrower's account is a member of a segment, the over-limit cushion module 120 determines the segment of which the borrower's account is a member. In a manner similar to that of step 806, the over-limit cushion 120 may compare data relating to the borrower's account with the data associated with each segment in the segmentation model in step 812. The borrower's account is a member of the segment defined by data that most closely matches the data relating to the borrower's account. Alternatively, step 812 may be performed approximately simultaneously with step 806. To identify the over-limit cushion to which the borrower is entitled, the over-limit cushion module 120 in step 814 accesses the optimal strategy from the optimization module 240 (or a database such as, credit provider database 700) and selects the over-limit cushion associated with the segment of which the borrower's account is a member. The over-limit cushion module 120 communicates the selected over-limit cushion with the over-limit processing module 140.

The over-limit processing module 140 uses the selected over-limit cushion to determine whether to approve or deny the over-limit amount. In step 816, the over-limit processing module 140 compares the over-limit cushion with the over-limit amount determined in step 805. If the over-limit cushion is less than the over-limit amount, the over-limit amount and thus the credit request is denied in step 808. In this case, the over-limit processing module 140 may communicate the denial of the credit request to the credit request system 300 in step 810. However, if in step 816 the over-limit cushion is greater than or equal to the over-limit amount, the over-limit processing module 140 approves the over-limit amount in step 818. The over-limit processing module 140 may communicate the approval or denial of the over-limit amount with the credit request system 300. Alternately, the over-limit processing module 140 may communicate the credit request with the credit analysis system 600 in step 820 so that the credit analysis system 600 may perform one or more additional analyses in connection with the credit request, such as those described above, to approve or deny the credit request.

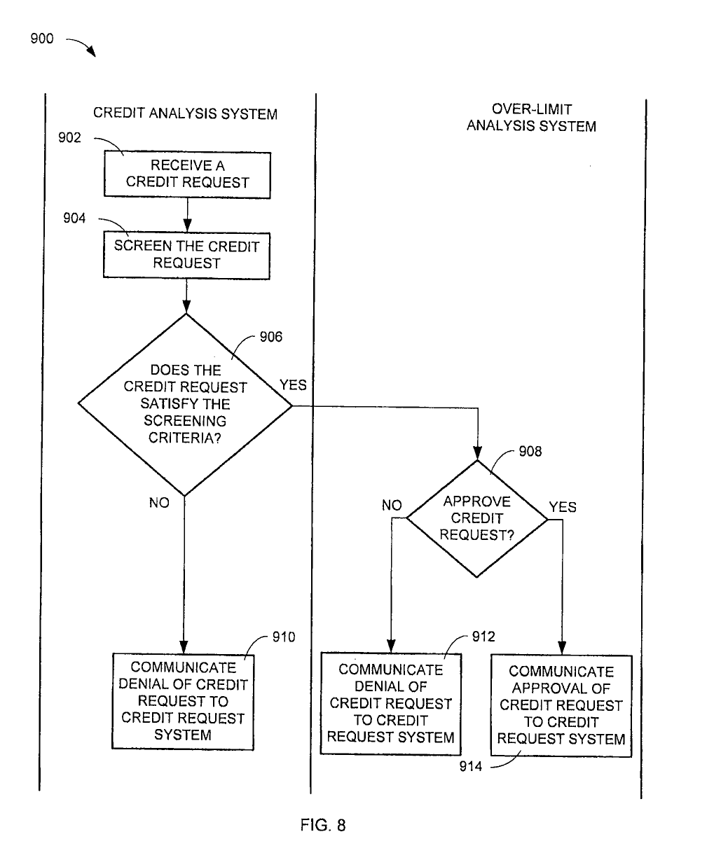

The credit system 10 may also include a credit analysis system 600 that may determine whether a credit request is approved or denied. FIG. 8 shows an example of a method for authorizing a credit request in real-time (a “credit analysis method”) 900. The credit authorization method 900 will be discussed with reference to FIG. 1 and FIG. 8. In this method 900, the credit analysis system 600 screens the credit request before the credit request is evaluated by the over-limit processing module 140. The credit analysis system 600 may screen the credit request by accessing information related to the account associated with the credit request from the credit provider database 700 or one or more other databases. In step 902, the credit analysis system 600 receives a credit request and, in step 904, screens the credit request according to one or more predefined screening criteria. For example, the screening criteria may require that the account associated with the credit request not be frozen and/or the borrower not be in bankruptcy. In another example, if the credit request is made via a credit card, the screening criteria may require that the credit card has not been stolen. If the credit request does not satisfy the screening criteria (as determined in step 906), the credit analysis system 600 will deny the credit request and communicate the denial to the credit request system 300 in step 910, Thus, under these circumstances, the over-limit analysis system 100 need not identify and/or analyze a request for an over-limit cushion.

If, however, the credit analysis system 600 determines that the credit request satisfies the screening criteria (step 906), the credit analysis system 600 may communicate the credit request with the over-limit analysis system 100. The over-limit analysis system 100 may determine whether to accept the credit request (step 908) according to, for example, the method shown in FIG. 7. If the over-limit analysis system 100 does not approve the credit request (step 908), the over-limit analysis system 100 may communicate the denial with the credit request system 300 (step 912). If, however, the over-limit analysis system 100 approves the credit request (step 908), the over-limit analysis system 100 may communicate the approval with the credit request system 300 (step 914).

An example of a way in which a credit system 10 that includes an over-limit analysis system 100 may be used by a borrower is presented in the following narrative and with reference to FIG. 1. A borrower with a credit account having only $800.00 in credit open to buy visits a home and garden store. While in the store, he becomes enamored with the store's newest riding mower costing $1000.00 and decides to buy the mower. In addition, the borrower may select, gather, and/or identify other items in the store that the borrower would like to purchase. For example, the borrower may select and gather a shovel and plant seeds, which collectively cost $50.00. The borrower may then proceed to the cash register with the shovel and the plant seeds. Because the riding mower is too large to take to the cash register, the borrower may take a document identifying the mower and its price so that the merchant may “ring up” the mower and provide delivery after the borrower has paid for it.

To pay for the selected items, the borrower's credit card information and information related to the purchase, such as the total price for the items including any tax, other fees and/or charges (collectively the credit request), is collected and communicated with the credit system 10 over a network. In this case, the credit system 10 determines that the credit request includes an over-limit amount of $250.00. Therefore, the credit system 10 interprets the credit request as including an implicit request for an additional amount of credit that, together with the borrower's credit open to buy, is sufficient to allow the borrower to purchase the selected items (a request for an over-limit amount). The over-limit analysis system 100 determines the amount of an over-limit cushion to which the borrower is entitled, if any. If the borrower is approved for an over-limit cushion, and the over-limit cushion equals or exceeds the over-limit amount, the credit system 10 will approve the credit request and communicate the approval to the merchant. Thus, the borrower is able to purchase the riding mower, shovel and plant seeds, even though the purchase price exceeds the credit open to buy on the purchaser's credit card.

In contrast, if the over-limit cushion is less than the over-limit amount, the over-limit amount and thus, the credit request will be denied. The credit system 10 may inform the merchant that use of the credit card has been denied and that the purchase price exceeds the borrower's credit limit. The credit system 10 may simply communicate to the merchant that the credit request has been approved or denied without communicating any of the details of the over-limit amount and/or over-limit cushion, rendering the over-limit analysis process invisible to the merchant (merchant) and/or the borrower. If the over-limit amount is denied, the borrower will not be able to use the credit to purchase the mower, shovel, and plant seeds.

In a different example, the same transaction could occur between a borrower and an eMerchant, and the credit determination could be communicated directly to the borrower.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A credit system for analyzing a credit request in real-time, the system comprising:
an first over-limit module configured to identify an over-limit amount in the credit request, and identify one of a plurality of over-limit cushions that corresponds with the credit request;
a second over-limit module in communication with the first over-limit module and configured to analyze the over-limit amount as a function of the over-limit cushion; and
a credit analysis system configured to approve or deny the credit request.

2. The system of claim 1, wherein the second over-limit module is further configured to approve or deny the over-limit amount as the result of the analysis of the over-limit cushion.

3. The system of claim 1, wherein the credit analysis system is further configured to approve or deny the credit request as the result of the analysis of the credit request.

4. The system of claim 1, wherein the first over-limit module is further configured to identify the over-limit cushion that corresponds to the credit request according to an optimal strategy.

5. The system of claim 4 further comprising a strategy development system configured to develop the optimal strategy by segmenting account data.

6. The system of claim 5, wherein the strategy development system includes a segmentation module configured to develop a segmentation model by segmenting the account data.

7. The system of claim 6, wherein the segmentation module is configured to develop the segmentation model by segmenting the account data according to a Chi-squared Automatic Interaction Detection method.

8. The system of claim 5, wherein the account data includes a transaction amount and/or a credit open to buy amount.

9. The system of claim 8, wherein the segmentation module is configured to segment the account data in a manner that approximately maintains a function of the transaction amount and the credit open to buy.

10. The system of claim 6, wherein the segmentation model includes a plurality of segments defined by the account data.

11. The system of claim 5, wherein the strategy development system includes an optimization module configured to further develop the optimal strategy.

12. The system of claim 11, wherein the optimization module is further configured to develop the optimal strategy by determining the plurality of over-limit cushions and associating the over-limit cushions with a plurality of segments.

13. The system of claim 11, wherein the optimization module is further configured to develop the optimal strategy according to an optimization method.

14. The system of claim 11, wherein the optimization module is further configured to develop the optimal strategy as a function of account data.

15. The system of claim 11, wherein the optimization module is further configured to develop the optimal strategy as a function of an optimization constraint.

16. The system of claim 15, wherein the optimization constraint includes a maximum over-20 limit cushion.

17. The system of claim 15, wherein the account data includes a transaction amount and the optimization constraint includes a maximum transaction amount that will be approved.

18. The system of claim 2, wherein the second over-limit module is further configured to approve or deny the over-limit amount according to a function of the over-limit amount and the over-limit cushion.

19. The system of claim 2, wherein the credit analysis system is further configured to approve or deny the credit request according to a function of the credit request, the borrower's credit open to buy and the over-limit cushion.

20. The system of claim 1, wherein the credit analysis system is further configured to screen the credit request.

21. The system of claim 1, wherein the credit analysis is further configured to communicate the result of the analysis of the credit request to the borrower.

22. A system for analyzing a credit request real-time, the system comprising:
a means for receiving the credit request from an borrower, identifying an over-limit amount in the credit request, and identifying one of a plurality of over-limit cushions that corresponds with the credit request;
a means for analyzing the over-limit amount as a function of the over-limit cushion; and
a means for analyzing the credit request; wherein the means for receiving, the means for approving or denying the over-limit amount, and/or the means for approving or denying the credit request are configured to communicate a result of the analysis of the credit request to the borrower.

23. A system for analyzing an over-limit amount in a credit request in real-time, the method comprising:
a first over-limit module configured to identify the over-limit amount in the credit request and to identify an over-limit cushion associated with the credit request; and
a second over-limit module in communication with the first over-limit module and configured to analyze the over-limit amount as a function of the over-limit cushion.

24. A method for analyzing a credit request in real-time, the method comprising:
receiving the credit request from an borrower;
identifying an over-limit amount in the credit request;
identifying one of a plurality of over-limit cushions that corresponds with the credit request;
analyzing the over-limit amount as a function of the over-limit cushion; and
analyzing the credit request as a function of the over-limit amount.

25. The method of claim 24, wherein analyzing the over-limit amount includes approving or denying the over-limit amount.

26. The method of claim 24, wherein analyzing the credit request includes approving or denying the credit request.

27. A method of analyzing an over-limit amount in a credit request in real-time, the method comprising:
identifying an over-limit amount in the credit request;
identifying one of a plurality of over-limit cushions that corresponds with the over-limit amount;
analyzing the over-limit amount as a function of the over-limit cushion.

28. The method of claim 27, wherein analyzing the over-limit amount includes approving or denying the over-limit amount.
